(19) United States
(12) Patent Application Publication
(10) Pub. No.: US 2009/0260565 A1
(43) Pub. Date: Oct. 22, 2009

(54) Apparatus for Continuously Producing Laminated Confectioneries

(75) Inventors: Jens FLEISCH, Wernigerode (DE); Alexander PREISLER, Wernigerode (DE); Erhard HILKER, Lemgo (DE)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CHOCOTECH GMBH, Wernigerode (DE)

(21) Appl. No.: 12/427,180

(22) Filed: Apr. 21, 2009

(30) Foreign Application Priority Data
Apr. 22, 2008 (DE) 10 2008 001 305.6

(51) Int. Cl. A23G 3/20; A23G 3/02

(52) U.S. Cl. 118/18; 118/13

(57) ABSTRACT

An apparatus (1) serves for continuously producing a laminated confectionary mass (14), especially halva, from a base mass (11) and a separating mass (12). The apparatus (1) includes a stator (2) and a rotor (3) being arranged to rotate in the stator (2). An inlet (10) serves to introduce the base mass (11) and the separating mass (12). The rotor (3) does not include a center shaft such that a free space (17, 26) being located in a center portion of the apparatus (1) and being surrounded by the rotor (3) is formed. The rotor (3) includes a plurality of elements (16, 21, 22, 23, 24, 30) to combine the base mass (11) and the separating mass (12) and to coat the base mass (11) with the separating mass (12) to attain the laminated confectionary mass (14), to extract the laminated confectionary mass (14) in the free space (17, 26) and to convey the extracted laminated confectionary mass (14) along a processing path (13) extending in an longitudinal direction of the apparatus (1).

### CROSS REFERENCE TO RELATED APPLICATIONS

This application claims priority to co-pending German Patent Application No. DE 10 2008 001 305.6 entitled “Verfahren und Vorrichtung zur kontinuierlichen Herstellung einer laminierten Süβwarenmasse”, filed Apr. 22, 2008.

### FIELD OF THE INVENTION

The present invention generally relates to an apparatus for continuously producing laminated confectionaries from at least one base mass and at least one separating mass. More particularly, the present invention relates to an apparatus for continuously producing halva.

Continuously producing such a mass is to be understood in contrast to discontinuous production of such a mass in which the mass is produced in batches.

### BACKGROUND OF THE INVENTION

An apparatus for continuously producing halwa is known from German Gebrauchsmuster No. DE 296 00 397 U1. The known apparatus includes a housing functioning as a stator and two rotors. The rotors are designed as two cooperating helixes including center shafts and spirals winding around the center shafts. The stator includes a double shell with which it can be heated with steam, for example. The rotational axes of the stator and of the two rotors are designed and arranged to be horizontal. The stator includes a first inlet for a separating mass in the form of an oilseed paste. The base mass, for example Turkish honey or a caramel mass, is extracted by a fiber forming device being located outside of the apparatus to attain single fibers. The produced fibers are then added to the separating mass in the apparatus via a second inlet. The fiber elongating device is located outside of the stator and on top of the stator such that elongation or extraction of the base mass is only attained without contact to the separating mass outside of the apparatus including the stator and the double helix. The formed fibers are then kneaded, mixed and conveyed together with the separating mass by the double helix. The double helix serves to knead, mix and convey the two masses. An exit having a reduced cross section is located at the downstream end of the apparatus. The lamination degree of the produced halva is determined by the fiber elongating device being located upstream of the apparatus.

Confectionary products having a laminated structure are generally known in the art for a long time. They are produced discontinuously, meaning in batches, by hand. The base mass is spread out as a layer, and the separating mass is placed on the layer of base mass. A thin flat structure including a multitude of layers is then produced by repeated folding, adding of additional separating mass and reducing the thickness of the layers.

It is also generally known in the art to use an apparatus for discontinuously producing laminated confectioneries in batches. The apparatus is designed as a lifting and kneading device including a kneading arm being driven to move approximately in accordance with the shape of an ellipse. During its movement, the arm enters a pan in which the mass is located. The pan is rotated about a vertical rotational axis.

Apparatuses for elongating sugar mass to attain fibers are known from German patent application No. DE 23 16 468 corresponding to U.S. Pat. No. 3,825,234 and from German patent application No. DE 26 04 983 A1. The apparatuses include driven pulling arms which are arranged to be preferably vertical and which pull fibers of sugar mass to extract these. The apparatuses only process one mass, and they do not serve to produce laminated masses.

### SUMMARY OF THE INVENTION

The present invention relates to an apparatus for continuously producing a laminated confectionary mass from at least one base mass and at least one separating mass. The apparatus includes a stator being designed as a housing and a rotor being arranged in the stator. At least one inlet is designed and arranged to introduce the base mass and the separating mass into the apparatus. The rotor is driven to rotate about a rotational axis. The rotor does not include a center shaft such that a free space being located in a center portion of the apparatus and being surrounded by the rotor is formed. The rotor includes a plurality of elements being designed and arranged to combine the base mass and the separating mass and to coat the base mass with the separating mass to attain the laminated confectionary mass, to extract the laminated confectionary mass in the free space and to convey the extracted laminated confectionary mass along a processing path extending in an longitudinal direction of the apparatus. An outlet is designed and arranged to be separate from the inlet and to discharge the laminated confectionary mass from the apparatus. The processing path extends between the inlet and the outlet of the apparatus.

The continuous production of laminated confectioneries is to be understood as a way of producing the laminated confectionary mass quasi continuously in contrast to a production in batches which is discontinuous. The laminated confectionary mass and the products produced therefrom at least include two masses, namely a base mass and a separating mass. Especially, the base mass may be a cooked or molten sugar mass. The separating mass is a fat mass or a mass containing fat. Typically, the two masses have different consistencies at room temperature. The cooked or molten base mass may be a solid mass at room temperature, while the separating mass is plastically deformable and soft at room temperature. However, during production of the laminated confectionary mass, the base mass also has to be plastically deformable. This means that it solidifies during or after the laminating process.

Laminated confectioneries having a comparatively flat structure are known. A typical example of such confectionaries is puff pastry or flaky pastry including comparatively large surface elements being formed by the base mass and being separated by the separating mass. However, the present invention is not directed to the production of such comparatively large and flat laminated confectioneries, but instead to masses having a fiber-like structure, as it is especially known from brittle or halva (also designated as halwa, halava, halawa, halvah, helva). The laminated confectionary mass includes a multitude of fibers being made of the base mass, being rather thin and being covered with the separating mass such that the fibers of base mass are separated and cannot stick together. The single fibers of this laminated confectionary mass mostly are not located to be parallel, but instead in a configuration looking similar to a ball of wool or a felt mat, and they are interconnected by the separating mass. The separating mass may be a fat mass or fatty mass including no water or only a small portion of water, the separating mass being softer than the base mass at room temperature after processing.

Products made of such a laminated confectionary mass have the above described fiber-like structure and very special bite characteristics resulting therefrom. There are different laminated masses differing with respect to the degree of lamination. The degree of lamination can be influenced by the thickness of the fibers of the extracted base mass, by the number of fibers and by the ratio of the amounts of the base mass and of the separating mass. It is desired to produce laminated confectionaries or sweats having a uniform degree of lamination in a reproducible way.

With the novel apparatus for continuously producing laminated confectioneries having a fiber-like structure, it is possible to reproducibly produce the masses by a machine and to effectively adjust the degree of lamination of the mass.

In addition to the inlets for the base mass and for the separating mass, the apparatus may include additional inlets especially being spaced apart along the length of the processing path. These inlets serve to introduce additional masses, as for example flavors, powders, milk powder, emulsifiers and/or rework. It is preferred to design and arrange the rotor such that its rotational speed can be controlled and adjusted. A rotational speed in a region of approximately 2 to 15 rotations per minute, especially 3 to 6 rotations per minute is preferred. A rotational speed of approximately 5 rotations per minute has been found to be especially advantageous. The stator and/or the rotor may be designed such that they can be tempered. For example, the stator may include a double shell through which a tempering medium flows for this purpose.

The rotor includes elements for conveying, extracting, coating and combining the masses along the processing path from the inlet towards the outlet to produce the laminated confectionary mass. These elements are designed and arranged to fulfill their respective function. The requirements for fulfilling these functions may be different along the processing path such that the elements are also distributed along the length of the processing path and such that they become effective in an alternating way. At the beginning of the processing path, it is primarily desired to convey the two masses and to bring these masses in contact with each other. In the center portion and towards the end portion of the processing path, it is primarily intended to pull, extract, coat, combine and interconnect the masses. The masses are also conveyed, but this conveying effect is more or less attained automatically. The elements for conveying, pulling, extracting, coating and combining the two masses are designed and arranged to be coordinated with the characteristics of the two masses and also to allow for the influence of gravity becoming effective. For this purpose, one or more free spaces are arranged in the interior of the stator, these free spaces also remaining free from the elements being located at the rotor. These free spaces serve to make it possible that agglomerated mass having the shape of loops drop down during rotation of the rotor. This dropping movement also results in the mass fibers being elongated and extracted and thus their diameter being reduced. In this way, one attains the desired structure of the laminated confectionary mass looking similar to a ball of wool or to felt. The fibers in the fibrous mass do not stick together, but they are rather located in a slightly spaced apart manner resulting in the desired bite characteristic of the confectionaries.

The rotor and the stator have a common rotational axis being arranged approximately horizontal to make use of the desired influence of gravity. However, the rotational axis may also be slightly declined. It makes sense to design the apparatus such that the angle of declination of the rotational axis is adjustable. In this way, the residing time of the masses in the apparatus during their movement along the processing path can be influenced and their conveying effect can be changed. These measures also determine the degree of lamination as well as the used rotational speed of the rotor, the length of the processing path, and the ratio of the amounts of base mass and separating mass as well as possible additional masses.

Especially, the elements for conveying, extracting, coating and connecting the masses along the processing path from the inlet towards the outlet may be one or more helixes not including a center shank, scraping combs, mandrels, pins, hook-shaped elements and the like. Especially, the helix not including a center shank is arranged in the beginning portion of the processing path to start the desired conveying effect without eliminating the influence of gravity. Such a helix not including a center shank provides for the desired free space since no center shank extends into the free space. A plurality of scraping combs either being designed to be straight or to include teeth may by arranged to be spaced apart the circumference, especially in the beginning portion of the processing path. These scraping combs may be connected to the helix not including a center shaft to commonly form a part of the rotor. Mandrels, pins and hooks are rather located in the second part of the processing path. They serve to repeatingly enter the mass during rotation of the rotor to convey loops of the mass in an upward direction and to then drop these loops resulting in the mass being extended and extracted during the upward movement as well as during the following dropping movement. These mandrels or pulling hooks preferably are not arranged to be exactly radial, but rather to be inclined with respect to the direction of rotation of the rotor such that their position is between a radial arrangement and a tangential arrangement. In this way, they transport the loop-shaped portions of the mass in an upward direction during their upward movement and that they fulfill their dropping function during which the mass loops slide off the elements and drop down since the fibers of base mass are covered by the separating mass.

In addition to the above described elements being arranged in the free space being formed in the rotor, it is also possible to arrange driven elements for pulling, coating and connecting the masses. However, it is not intended that such an arrangement eliminates the influence of gravity due to the free space being too small. The design and arrangement of the different elements preferably changes along the length of the processing path as it has been described above such that the additional driven elements are especially arranged in the second part of the processing path. Such an arrangement can be realized in an especially simple way since the outlet is designed to be open anyway such that the elements can easily protrude into the interior of the stator to there fulfill their function.

With the novel apparatus, the masses are introduced into the apparatus at the inlet of the apparatus for continuously producing laminated confectioneries. The masses at least include at least one base mass and at least one separating mass. The base mass contains sugar and the separating mass contains fat. Generally, the masses are introduced into the apparatus without special treatment of the masses in advance. However, it is to be understood that it is possible and necessary, respectively, to cook the base mass in advance. The base mass needs to have a certain temperature for attaining its desired ductility. However, it is also possible that the base mass is introduced in an aerated condition. The separating mass when being introduced into the apparatus has a temperature which usually is substantially lower than the temperature of the base mass. The masses are especially introduced in a spaced apart manner along the longitudinal direction of the apparatus, meaning along the processing path, the separating mass being first introduced and the base mass being introduced afterwards.

The base mass and the separating mass are combined in the apparatus, meaning in the interior of the stator where the rotor is arranged, at the beginning of a processing path being formed by the driven rotor not including a center shaft and the housing of the apparatus functioning as a stator. In the following, as the mass is moved along the processing path, the base mass is coated with the separating mass, the base mass being coated with the separating mass is extracted, the extracted masses are further conveyed and combined and finally the laminated confectionary mass is discharged from the apparatus. These processing steps take place along the processing path being formed by the rotor and the stator and extending in the longitudinal direction of the apparatus. The conveying effect is of special importance at the beginning portion of the processing path, the two masses also being removed from the inner wall of the stator, the masses being brought into contact with each other and the masses starting to be conveyed. This processing step takes place under the influence of gravity such that the masses are located in a free space being arranged in the inside of the rotor in which they may drop down. In the following, the masses are intensively extracted resulting in the masses contacting each other being deformed to longitudinal units having a fiber-like structure. They are covered with the separating mass which preferably takes place over the entire circumference of the fiber-like extracted elements of base mass. The coating of the base mass with separating mass prevents the fiber-like extracted elements of base mass from getting in direct contact with each other and from sticking together. At the same time, it is necessary to recombine the coated extracted fibers of the base mass to attain the desired laminated structure of the confectionary mass. Finally, the laminated confectionary mass is more or less continuously discharged from the apparatus. In this sense, continuous discharge also means that it is possible to discharge different amounts of lumps or portions of the mass.

Preferably, introducing and/or discharging the masses is realized in a continuous way, the separating mass and the base mass being introduced in a dosed way one after the other. The ratio of the amounts of base mass and of separating mass may be varied. Especially, it may be in a range of approximately between 30% and 70%.

However, it is also possible to completely or partly premix the base mass and the separating mass and to introduce this premixed mass into the processing path in the apparatus. It is also possible to use aerated base masses.

However, it is preferred to introduce the two masses separately at separate locations of the processing path being formed in the apparatus. The base mass as a cooked sugar mass usually has substantial bonding properties. Consequently, to prevent sticking of the sugar mass to the elements of the apparatus, the separating mass is first introduced, the separating mass having bonding properties which are substantially less than the bonding properties of the bass mass.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a vertical sectional view of a first exemplary embodiment of the novel apparatus 1 for continuously producing laminated confectioneries.

FIG. 2 is a prospective view of the rotor of the apparatus according to FIG. 1.

FIG. 3 is a vertical sectional view of a second exemplary embodiment of a novel apparatus for producing laminated confectioneries, the rotational axis being arranged to be declined.

FIG. 4 is a vertical sectional view of a third exemplary embodiment of the novel apparatus for producing laminated confectioneries.

### DETAILED DESCRIPTION

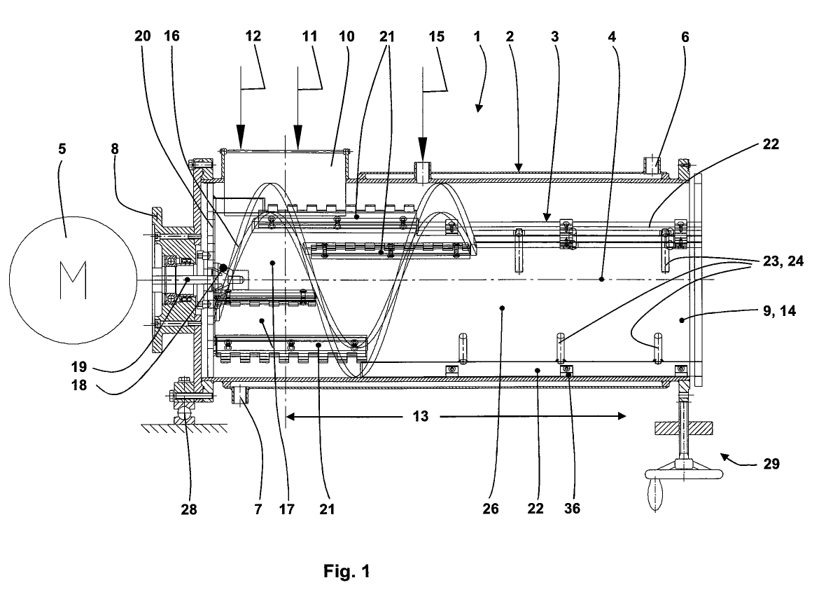

FIG. 1 illustrates a first exemplary embodiment of a novel apparatus 1 for producing a laminated confectionary mass. The apparatus 1 includes a stator 2 being designed to be stationary and to function as a housing. A rotor 3 is arranged inside of the stator 2. The stator 2 and the rotor 3 substantially have a cylindrical shape with a common rotational axis 4. The rotor 3 is rotatingly driven by a motor 5 which is only schematically illustrated. Especially, the motor 5 drives the rotor 3 at comparatively low numbers of rotation, for example in a region of approximately 2 to 20 revolutions per minute. It is also possible to arrange a reduction gear between the motor 5 and the rotor 3.

It is possible to connect the stator 2 to a tempering circuit, especially a cooling circuit for removing heat from the masses. The cooling circuit may be connected to a connecting piece 6, and it may be operated according to the countercurrent principle, the cooling medium being removed by an element 7. The stator 2 is designed as a stationary housing including a cylindrical inner wall and to be closed on the side of the motor 5 by a face wall 8. The drive for the rotor 3 extends through the face wall 8. The stator 2 at its side facing away from the motor 5 is designed to be opened and to include an outlet 9. The stator 2 also includes an inlet 10 being separate from the outlet 9. The inlet 10 serves to introduce a base mass 11 and a separating mass 12. Instead of one common inlet 10, it is also possible to arrange a plurality of separate inlets 10 being arranged one after the other in a spaced apart manner as it is schematically illustrated by the arrows indicating the introduction of the separating mass 12 and of the base mass 11.

The base mass 11 is a cooked sugar mass or at least a mass including sugar. The base mass 11 has been substantially heated, especially cooked, to attain a condition in which it is kneadable. The separating mass 12 is a fat mass or a mass containing a substantial portion of fat, for example nut nougat, sesame paste, peanut paste, and the like. The separating mass 12 is still soft and kneadable at room temperature after having been processed, whereas the base mass 11 is firm, hard and brittle at room temperature as it is for example known from hard candy.

A processing path 13 is formed between the inlet 10 and the outlet 9. The processing path 13 substantially extends over the entire length of the rotor 3 and of the stator 2. At the end of the processing path 13, the base mass 11 and the separating mass 12 have been deformed and processed, respectively, to attain a laminated confectionary mass 14. The details of the masses are not illustrated in the drawings for reasons of clarity of the drawings. The laminated confectionary mass 14 has a structure including fibers, the fibers having different diameters depending on the lamination degree, and they may also contact one another in different ways to form a structure looking somewhat similar to the one a ball of wool or felt.

During production of the laminated confectionary mass 14, in addition to the base mass 11 and the separating mass 12, additional masses 15 may be introduced into the apparatus 1. For example, these additional masses 15 may be flavors, colors, powders, emulsifiers, and the like. The place where the additional masses 15 are introduced depends on the temperature sensitivity of the respective different masses. Preferably, the base mass 11 is cooked at a temperature of approximately between 120° C. to 140° C., and it is cooled afterwards. While the base mass 11 is introduced at a comparatively high inlet temperature, for example in a range of approximately between 80° C. to 110° C., the separating mass when being introduced has a temperature of approximately between 40° C. to 50° C. The temperature of the mixed and conveyed base mass 11 and separating mass 12 is reduced along the processing path 13, but it is still high enough to allow for the laminated confectionary mass 14 still being deformed and processed.

The rotor 3 may include different elements at least partly fulfilling different functions. A helix 16 not including a core (or center shaft) is arranged in the first part of the processing path 13. The helix 16 surrounds a free space 17. The free space 17 is substantially free, one possible exception being the shaft end 18 of a driving shaft 19 slightly protruding into the free space 17. The helix 16 is connected to a face plate 20 being connected to the driving shaft 19. The helix 16 substantially fulfills the conveying function for the masses 11 and 12. Scraping combs 21 are arranged at the helix 16, especially between the protruding elements of the helix 16 and the face plate 20. The scraping combs 21 substantially extend in an axial direction, meaning parallel to the rotational axis 14, and they are inclined with respect to the circumference of the inner wall of the stator 2. The scraping combs 21 are spaced apart the circumference, and they may have a scraper-like cross section or include teeth, as this is illustrated in FIG. 1. The scraping combs 21 substantially serve to mix the masses 11 and 12, to repeatingly remove the masses 11 and 12 from the inner wall of the stator 2, and to maintain them in a tumbling movement using the influence of gravity in the free space 17. In this way, the masses 11 and 12 are mixed in a way that one attains portions of the base mass 11 being covered by the separating mass 12 to be more or less encompassed by the separating mass 12.

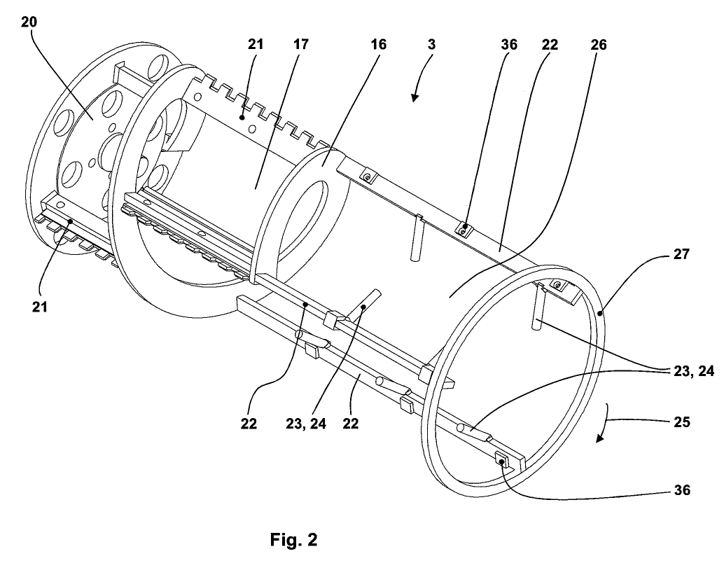

It is also possible to arrange comb-shaped elements 22 in the region of the second part of the processing path 13 as seen in a direction towards the outlet 9. These elements 22 are also arranged to be inclined with respect to the inner wall of the stator 2, to form a gap therebetween and to substantially extend in an axial direction. These elements 22 also fulfill a conveying function. In addition, they serve as carriers for arbors or mandrels 23 the design and arrangement is to be best seen in FIG. 2. The mandrels 23 may have the shape of pins 24, but it is also possible that they are hook-shaped or otherwise bent. The mandrels 23 and the pins 24, respectively, serve to repeatingly capture parts of the mixed mass including the masses 11 and 12 during rotation of the rotor 3 to upwardly convey these portions of the mass and to drop these portions of the mass when they are located in an upper region. During the upward movement, the base mass 11 is extracted, extended, drawn and pulled, meaning the diameter of the fiber-like material is reduced and its length is increased. When the mass is dropped from the upper region, gravity is used to reunite the loops such that one attains a structure of the laminated confectionary mass 14 which looks similar to a ball of wool or felt. Depending on the length of the processing path 13 and other parameters, the laminating degree of the laminated confectionary mass 14 can be adjusted in a reproducible way to attain different results as desired. It is to be seen that a free space 26 is also arranged in the second part of the processing path 13, the second free space 26 continuing the free space 17 and fulfilling a similar function as the free space 17, respectively. In this second free space 26, gravity also acts upon the masses 11 and 12. The comb-shaped elements 22 may include supporting elements 36 serving to support the rotor 3 in the stator 2 in a freely projection way. The comb-shaped elements 22 may also be interconnected at the side of the outlet 9 by a carrier ring 27 also serving to reinforce the rotor 3 (see FIG. 2).

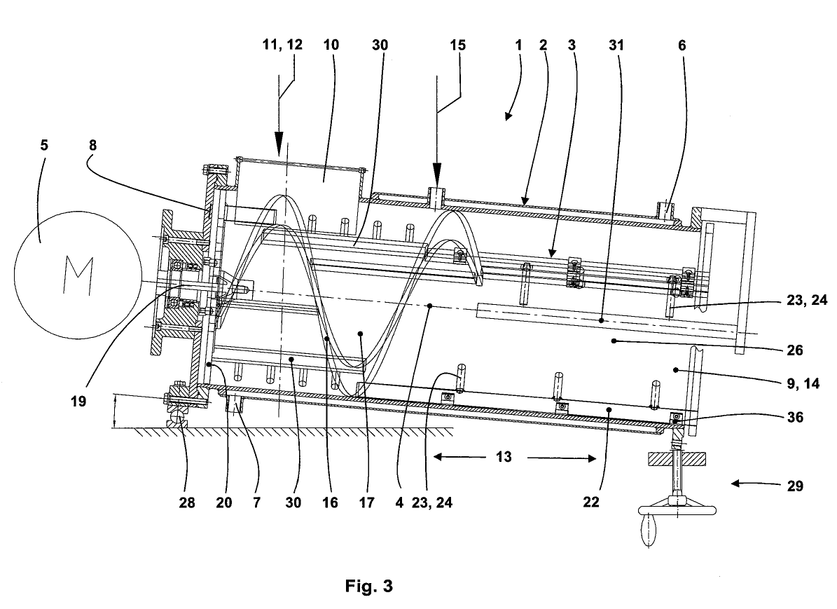

It is to be seen in FIG. 1 that the apparatus 1 is arranged such that its axis 3 is arranged approximately horizontal. However, the stator 2 may also include a bearing 28 being designed and arranged such that it cooperates with an adjustment unit 29 in a way to change the angle of declination of the rotational axis 4, as this is indicated in FIG. 3. This is another possibility of adjusting the degree of lamination of the mass 14. The declination of the rotational axis 4 has a positive effect on the conveying effect, and it decreases the residing time of the masses 11 and 12 inside of the apparatus 1 and during their movement along the processing path 13, respectively.

FIG. 3 illustrates another exemplary embodiment of the novel apparatus 1 including the stator 2 and the rotor 3. The apparatus 1 according to FIG. 3 has many features in common with the apparatus 1 illustrated in FIGS. 1 and 2 such that it is referred to the above description. Alternatively or additionally to the scraping combs 21 of the apparatus 1 illustrated in FIGS. 1 and 2, pin bars 30 are arranged at the helix 16. Another special feature of the embodiment of the apparatus 1 according to FIG. 3 is a reverting arbor 31 being located at the stator 2 close to the outlet 9 and to protrude in the centre of the outlet 9, meaning in the rotational axis 4 in a stationary way. Depending on the movement of the mass elements being produced within the free space 26, the reverting arbor 31 may also be arranged to be slightly eccentric. It is not intended that the reverting arbor 31 eliminated the effect of the free space 26. Instead, it is intended that the loop-shaped portions of the mass are placed on the reverting arbor after their upward movement and their following downward movement from the arbors or mandrels 23 and the pins 24, respectively. In this way, these mass portions are supported on the reverting arbor 31 similar to a clothesline resulting in the extracting and pulling effect of the fibers of the base mass 11 being increased. Due to the fact that this extracting and drawing effect is substantially intended to take place in the second part of the processing path 13, the reverting arbor 31 is substantially not arranged in the first part of the processing path 13 such that the free space 17 completely fulfills its function.

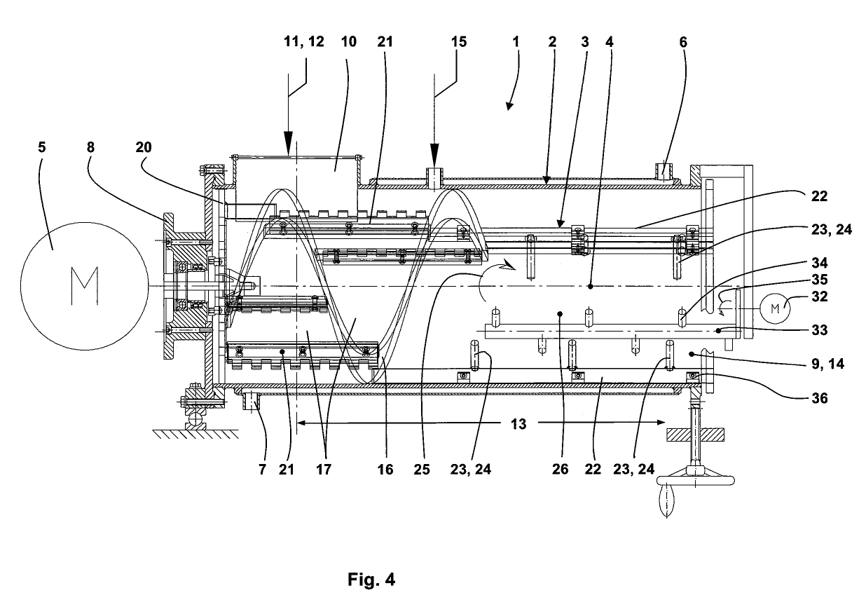

The exemplary embodiment of the novel apparatus 1 illustrated in FIG. 4 has a lot of features in common with the embodiment of the apparatus 1 illustrated in FIGS. 1 and 2. Consequently, it is referred to the above description. In contrast, the apparatus 1 includes a driven processing element being supported on the stator 2 and protruding into the open outlet 9 and into the free space 26. This processing element includes a shaft 33 being driven by a motor 32 and including a plurality of pins 34 being arranged to be coordinated with the mandrils 23 and the pins 24, respectively. Preferably, the shaft 33 is rotated in an opposite direction according to arrow 35. This additional processing element and its drive are designed and arranged such that they do not negatively influence the effect of the free space 26, on the one hand, and such that the degree of lamination of the laminated confectionary mass can be increased, on the other hand.

Many variations and modifications may be made to the preferred embodiments of the invention without departing substantially from the spirit and principles of the invention. All such modifications and variations are intended to be included herein within the scope of the present invention, as defined by the following claims.

We claim:

1. An apparatus for continuously producing a laminated confectionary mass from at least one base mass and at least one separating mass, comprising:
a stator, said stator being designed as a housing;
at least one inlet, said inlet being designed and arranged to introduce the base mass and the separating mass into said apparatus;
a rotor,
said rotor being arranged in said stator,
said rotor being driven to rotate about a rotational axis,
said rotor not including a center shaft such that a free space being located in a center portion of said apparatus and being surrounded by said rotor is formed,
said rotor including a plurality of elements being designed and arranged to combine the base mass and the separating mass and to coat the base mass with the separating mass to attain the laminated confectionary mass, to extract the laminated confectionary mass in the free space and to convey the extracted laminated confectionary mass along a processing path extending in an longitudinal direction of said apparatus; and
an outlet, said outlet being designed and arranged to be separate from said inlet and to discharge the laminated confectionary mass from said apparatus, said processing path extending between said inlet and said outlet of said apparatus.

2. The apparatus of claim 1, wherein one of said elements of said rotor is a helix.

3. The apparatus of claim 1, wherein said rotor includes a plurality of scraping combs, said scraping combs being connected to said rotor in a spaced apart manner about the circumference of said rotor and to be commonly rotated therewith.

4. The apparatus of claim 2, wherein said rotor includes a plurality of scraping combs, said scraping combs being connected to said rotor in a spaced apart manner about the circumference of said rotor and to be commonly rotated therewith.

5. The apparatus of claim 1, wherein said rotor includes at least one element selected from the group consisting of scraping combs, mandrels and pins.

6. The apparatus of claim 1, wherein said rotor includes a second free space in addition to the first free space, said first free space being located adjacent to said inlet and said second free space being located adjacent to said outlet, said second free space being designed and arranged to extract and combine the base mass and the separating mass.

7. The apparatus of claim 6, wherein said rotor includes a plurality of pins, said pins being connected to said rotor in a spaced apart manner about the circumference of said rotor and to be commonly rotated therewith, said pins being designed and arranged to protrude into the second free space.

8. The apparatus of claim 6, further comprising a driven shaft including a plurality of pins, said pins extending from said shaft approximately in a radial direction, said shaft being arranged in a region below the second free space.

9. The apparatus of claim 1, wherein the rotational axis is substantially horizontal.

10. The apparatus of claim 1, wherein said rotational axis is designed and arranged in a way that its angle of declination is adjustable.

11. The apparatus of claim 1, wherein the laminated confectionary mass is halva.

12. The apparatus of claim 2, wherein the laminated confectionary mass is halva.

13. The apparatus of claim 3, wherein the laminated confectionary mass is halva.

14. The apparatus of claim 1, wherein the base mass is a sugar containing mass and the separating mass is a fat containing mass.

15. The apparatus of claim 2, wherein the base mass is a sugar containing mass and the separating mass is a fat containing mass.
